(19) United States
(12) Patent Application Publication
(10) Pub. No.: US 2014/0122796 A1
(43) Pub. Date: May 1, 2014

(54) SYSTEMS AND METHODS FOR TRACKING A SEQUENTIAL DATA STREAM STORED IN NON-SEQUENTIAL STORAGE BLOCKS

(71) Applicant: NETAPP, INC., Sunnyville, CA (US)

(72) Inventor: Rodney A. DeKoning, Wichita, KS (US)

(73) Assignee: NetApp, Inc., Sunnyville, CA (US)

(21) Appl. No.: 13/664,558

(22) Filed: Oct. 31, 2012

(51) Int. Cl. G06F 12/08

(52) U.S. Cl. 711/114; 711/E12.019

(57) ABSTRACT

A process for block-level tracking of a sequential data stream that is sub-divided into multiple parts, and stored, by a file system, within non-sequential storage blocks. The process creates block-level metadata as the sequential data stream is written to the storage blocks, wherein the metadata stores pointers to the non-sequential storage blocks used to store the multiple parts of the sequential data stream. This metadata can subsequently be used by a block-level controller to more efficiently read the sequential data stream back to the file system using read-ahead processes.

### TECHNICAL FIELD

The systems and methods described herein relate to storage systems, and more particularly, to keeping track of a sequential data stream in a storage system such that it may be read from non-sequential storage blocks efficiently.

### BACKGROUND

To achieve high levels of storage capacity for long-term storage, storage systems typically use arrays of storage disks, or hard disk drives (HDDs). HDDs are based upon a relatively mature technology, and are a form of non-volatile memory that use a spinning magnetic disk, or platter, which is typically driven at speeds of 5400, 7200, 10,000, or 15,000 rpm. Information is written onto this spinning magnetic disk using a moving read and write head, wherein information, in the form of bits, is stored by changing the magnetization of a thin ferromagnetic layer on top of the rotating disk using the movable head. HDDs offer the advantage of a lower cost per unit storage capacity when compared to alternative storage options, such as solid state drives (SSDs).

SSDs, however, are becoming increasingly popular for use in personal computers for persistent storage of data, and for use in separate storage tiers of large storage systems to offer faster data read and write speeds than HDDs, such that SSDs may be used for caching and buffering data. In contrast to HDDs, the technology used to manufacture SSDs, which includes the use of arrays of semiconductors to build memory blocks, is relatively immature. Consequently, the cost per unit storage capacity may be an order of magnitude higher than for HDDs, making SSDs prohibitively expensive for extensive use in storage systems, wherein storage systems may use thousands of storage devices to provide storage capacities of thousands of terabytes (TBs).

Some storage system applications have very high service level objectives (SLO) that HDDs cannot meet without using read-ahead techniques. Delivery of high-definition video with a refresh rate of 60 frames per second (60 Hz), for example, may require that a request be returned to a requesting client every 17 ms. A returned request may be a frame sized between, for example, 10 and 15 MB. HDDs have a relatively long access time, which is an average time for a HDD to rotate the disk and move a read-head over a part of the disk in order to read data. In some instances the average access time may be 10 ms, which may be two orders of magnitude slower than for a SSD, and wherein the 10 ms access time does not take account of processing time. In other instances, the delivery of data requested from a HDD may be delayed by transient issues, such as a drive software problem that causes the HDD to reset or reboot. Other forms of delay to the delivery of data from a HDD may include the drive having to re-try reads or repair data. As such, storage systems may use read-ahead techniques to anticipate which data will be requested in the future, and to buffer this data into memory with faster access time. This allows storage systems to meet high SLOs, despite limited data delivery rates associated with HDDs.

In some embodiments, a storage system may abstract its storage locations away from storage blocks on a physical HDD, such that all or part of the physical storage space available to a storage system is presented, by a disk array controller, as one or more emulated storage drives. This methodology is used with Redundant Array of Independent Disks (RAID) storage techniques, wherein the emulated storage drives are referred to as virtual storage volumes, RAID volumes or logical units. Multiple physical HDDs may make up a RAID volume, which is accessed by a file system or application running on a host computer as if it is a single storage drive. Different RAID levels (RAID 0, RAID 5, RAID 6, RAID 10, among others) offer different types of storage redundancy and read and write performance from and to the multiple physical HDDs. A RAID controller, or disk array controller, implemented as a hardware controller in communication between a HDD array and a host adapter of a computer, may be employed to implement RAID techniques. In other instances, the disk array controller may be a software controller built into the computer operating system.

A disk array controller essentially hides the details of the RAID volume from the file system or other application, and presents the file system or application with one or more RAID volumes. Each RAID volume then presents the behavior of a single storage device from the perspective of the application or file system. The disk array controller presents the file system or application with a range of logical block addresses (LBAs) at which data may be stored or retrieved. Once the file system or application sends an instruction to store data at a specific LBA, the disk array controller maps this LBA to physical storage blocks associated with a storage device. This mapping, from the LBAs presented to the file system or application, to the storage blocks, allows the disk array controller to distribute data across multiple storage devices that make up the RAID volume.

The distribution of a sequence of data among different physical HDDs is known as striping. A RAID stripe may be made up of multiple segments, wherein each segment may be the size of a hard disk block (the size of a disk block may range from 512 to 4096 bytes, but it should be understood that hard disk block sizes outside of this range are also possible). Each segment is stored on a different storage device, wherein the size of the RAID stripe may be a multiple of the hard disk block size of one of the HDDs that make up the RAID volume. RAID stripe sizes may, for example, be of the order of tens of kilobytes (kB), but a RAID stripe size may vary depending on the number of HDDs that make up the RAID volume, and the hard block size of the HDDs.

In another implementation, a further level of abstraction may be employed to create large stripe sizes that span thousands of hard disk blocks and each contain thousands of segments of RAID stripes. In the explanation that follows, these large stripes may be referred to as C-stripes, and the sub-division of a C-stripe referred to as a C-piece. The systems and methods described herein can be applied to C-pieces and hard disk blocks, which can be collectively referred to as storage blocks.

When presented with a range of LBAs, it is the file system or application that decides where within this range to store data. The file system or application may store a sequence of data, such as a video file, in non-sequential LBAs that correspond to non-sequential storage blocks on one or more storage devices. There is no communication between the file system or application, and the block-level storage array controller, on how to make efficient use of the physical storage space that makes up a RAID volume, or how a data stream is being stored in storage blocks. As a consequence, read performance from the RAID volume may not be able to meet high SLOs for data reads from a RAID volume. In response, a disk array controller may employ various forms of buffering.

A buffer is generally a store of data in memory with low latency, or short access time. Examples of hardware suitable for use as buffers include SSDs (previously described), random access memory (RAM), which is a form of volatile memory, and storage class memory (SCM). Read-ahead processes may also be used to anticipate which data, from a sequence of data, will be requested in the near future. A read-ahead process, in response to anticipating the data that will be requested in the near future, writes the anticipated data to a buffer.

A block-level storage array controller, however, cannot make efficient use of read-ahead processes to predict which part of a sequential data stream stored in non-sequential hard disk blocks will be requested in the future. This is due to the lack of information available to the block-level storage array controller about where within the range of LBAs presented to the file system that the parts of the sequential data stream are stored.

As such, there is a need for a more efficient method of tracking a stream of sequential data divided among non-sequential storage blocks such that the stream may be efficiently read from the storage system using read-ahead techniques.

### SUMMARY

The systems and methods described herein include, among other things, a process for block-level tracking of a sequential data stream that is sub-divided into multiple parts, and stored, by a file system, within non-sequential storage blocks. The process creates block-level metadata as the sequential data stream is written to the storage blocks, wherein the metadata stores pointers to the non-sequential storage blocks used to store the multiple parts of the sequential data stream. This metadata can be used by a block-level controller to more efficiently read the sequential data stream back to the file system using read-ahead processes.

In one aspect, the systems and methods described herein relate to a method for reading a data stream that is stored in non-sequential storage blocks. The method includes the steps of storing two parts of a data stream in two non-sequential storage blocks. A stream metadata processor is used to generate a first metadata block to be associated with a first storage block and stores a pointer to a second storage block in the first metadata block. A read-ahead processor is used to read the metadata block such that the pointer can be used to buffer the data stored in the second storage block before it is requested from a computer system.

In one embodiment, the method includes the step of generating the first metadata block and a second metadata block by the stream metadata processor as the stream is being stored in the storage blocks.

In another embodiment, the storage blocks are physical blocks on a storage device.

In yet another embodiment, the storage blocks are subdivisions of a virtual storage volume.

In a further embodiment, the first and second metadata blocks are stored in separate memory locations to the parts of the sequential data stream.

In still another embodiment, the metadata blocks are stored in a metadata block array.

In one embodiment, the pointer is generated by determining the logical block address where the second metadata block is stored.

In another embodiment, the pointer has a null value if the first storage block stores the end of the data stream.

In a further embodiment, the stream metadata processor stores an offset value in the first metadata block to the point in the second storage block at which a part of the data stream is stored.

The offset value may be a number of bytes.

In one embodiment, the method uses the stream metadata processor to store a logical unit number in the first and the second metadata blocks corresponding to physical storage devices used to store the first and second storage blocks of data.

In yet another embodiment, the method stores a size value in the first or the second metadata block using the stream metadata processor, and a size value corresponds to the end point of a part of the data stream within the respective first or second storage block.

The method may use a metadata update processor to update the first metadata block if the requesting computer system requests a third part of the data stream instead of the part stored in the second storage block.

In another embodiment, the requesting computer system uses file metadata to request the two parts of the data stream, and the file metadata is not available to the read-ahead processor.

In another aspect, the systems and methods described herein include a system for improving the read performance of a data stream stored in two non-sequential storage blocks, and includes a stream metadata processor for storing two parts of a data stream in the two storage blocks. The stream metadata processor can further generate a first metadata block associated with the first storage block, and store a pointer to the second storage block in the first metadata block. The system also includes a read-ahead processor to buffer, using the metadata, the second part of the data stream before a request is made from a requesting computer system.

In another embodiment, the system uses a stream metadata processor to generate the first and a second metadata block as the stream is stored in the first and second storage blocks.

The first and second storage blocks may be physical blocks on one or more storage devices.

In another embodiment, the first and second storage blocks are subdivisions of a virtual storage volume.

In another embodiment, the first and second metadata blocks are stored separately from the first and second storage blocks.

The first and second metadata blocks may be stored in a metadata block array.

In another embodiment, the system generates the pointer by determining the logical block address where the second metadata block is stored.

In yet another embodiment, the system generates the pointer with a null value if the first storage block stores the end of the data stream.

The stream metadata processor may store an offset value in the first metadata block that represents the start of the second part of the data stream in the second storage block.

The offset value may be a number of bytes.

In another embodiment, the stream metadata processor may store a logical unit number in a metadata block corresponding to the physical storage devices used to store the data associated with a storage block.

In another embodiment, the system uses the stream metadata processor to store a size value in a metadata block corresponding to the end point of a part of the data stream within a storage block.

The system may use a metadata update processor to update the first metadata block if the requesting computer system requests a third part of the data stream instead of the part stored in the second storage block.

In another embodiment, the requesting computer system uses file metadata to request the two parts of the data stream, and the file metadata is not available to the read-ahead processor.

In another aspect, the systems and methods described herein include a method for management of the storage of a data stream, including steps for dividing the data stream into segments, storing the segments in blocks of a block-level storage system, and storing metadata in the block-level storage system with a pointer from a first storage location to second storage location storing a first segment of the data stream, and a second segment of the data stream. The method further includes the use of a read-ahead process to buffer the second segment, using the metadata to anticipate when the second segment will be requested by a file system.

### BRIEF DESCRIPTION OF THE DRAWINGS

The systems and methods described herein are set forth in the appended claims. However, for purpose of explanation, several embodiments are set forth in the following figures.

FIG. 1 is a schematic block diagram of an exemplary storage system environment, in which some embodiments operate.

FIG. 2 is a schematic block diagram of an exemplary embodiment of a storage enclosure RBOD (RAID Box of Disks).

FIG. 3 is a schematic block diagram of a block tracking controller, as described herein for use in the storage system environment of FIG. 1 and storage enclosure of FIG. 2.

FIGS. 4A-4C schematically depict a process for tracking a sequential data stream stored in non-sequential storage locations.

FIGS. 5A and 5B depict metadata structures used to track sequential data streams.

FIG. 6 is a flowchart diagram of a process for tracking a data stream.

### DETAILED DESCRIPTION

In the following description, numerous details are set forth for purpose of explanation. However, one of ordinary skill in the art will realize that the embodiments described herein, which include systems and methods for tracking a sequential data stream, may be practiced without the use of these specific details, which are not essential and may be removed or modified to best suit the application being addressed. In other instances, well-known structures and devices are shown in block diagram form to not obscure the description with unnecessary detail.

In one embodiment, the systems and methods described herein include, among other things, a process for block-level tracking of a sequential data stream that is sub-divided into multiple parts, and stored, by a file system, within non-sequential storage blocks. The process creates block-level metadata as the sequential data stream is written to the storage blocks. The metadata stores pointers to the non-sequential storage blocks used to store the multiple parts of the sequential data stream, such that this metadata can be used by a block-level controller to more efficiently read the sequential data stream back to the file system using read-ahead processes.

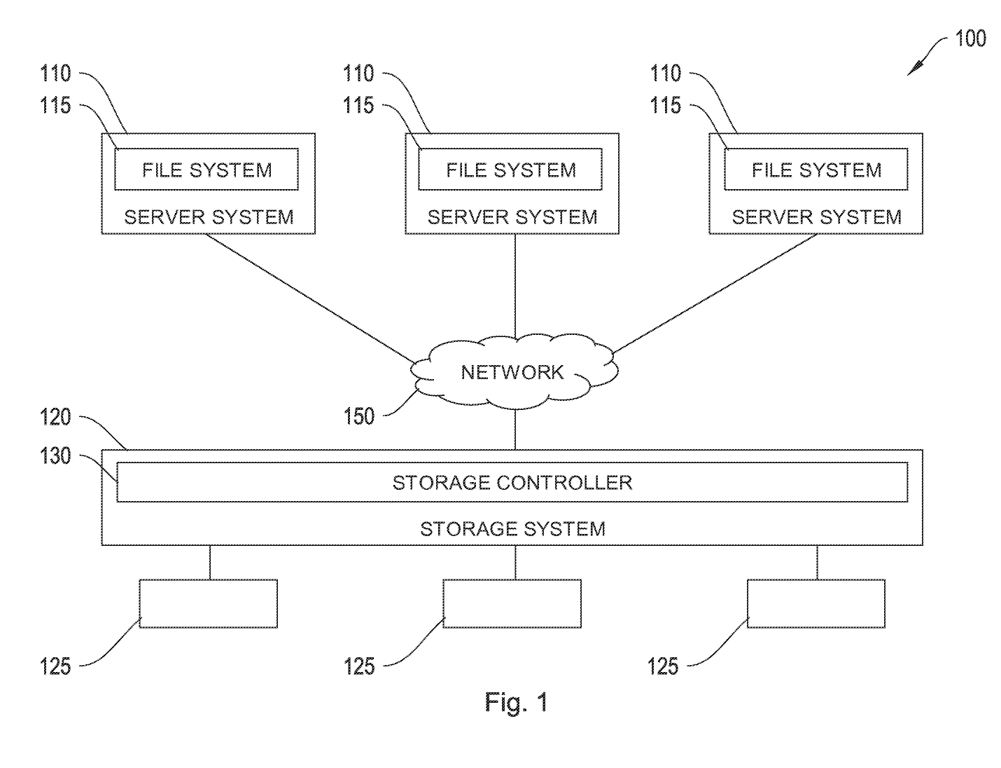

FIG. 1 is a schematic block diagram of an exemplary storage environment 100, in which some embodiments may operate. Environment 100 has one or more server systems 110 connected by a connection system 150 to a storage system 120, wherein the storage system 120 has a storage controller 130 for controlling one or more storage devices 125. The connection system 150 may be a network, such as a Local Area Network (LAN), Wide Area Network (WAN), metropolitan area network (MAN), the Internet, fiber channel (FC), SAS (serial attached small computer system interface (SCSI)), or any other type of network or communication system suitable for transferring information between computer systems.

A server system 110 may include a computer system that employs services of the storage system 120 to store and manage data in the storage devices 125. A server system 110 may execute one or more applications that submit read/write requests for reading/writing data on the storage devices 125. Interaction between a server system 110 and the storage system 120 can enable the provision of storage services. That is, server system 110 may request the services of the storage system 120 (e.g., through read or write requests), and the storage system 120 may perform the requests and return the results of the services requested by the server system 110, by exchanging packets over the connection system 150. The server system 110 may issue access requests (e.g., read or write requests) by issuing packets using block-based access protocols, such as the Fibre Channel Protocol (FCP), or Internet Small Computer System Interface (iSCSI) Storage Area Network (SAN) access, when accessing data in the form of blocks.

The storage system 120 may store data in a set of one or more storage devices 125. The storage objects may be any suitable storage object such as a data file, a directory, a data block or any other logical object capable of storing data. A storage device 125, may be considered to be a hard disk drive (HDD), but should not be limited to this implementation. In other implementations, storage device 125 may be another type of writable storage device media, such as video tape, optical disk, DVD, magnetic tape, any other similar media adapted to store information (including data and parity information), or a semiconductor-based storage device such as a solid-state drive (SSD), or any combination of storage media, wherein the storage space available to a storage medium may be subdivided into logical objects (e.g., blocks), and a data stream may be stored in those blocks.

The storage system 120 may be a block-level (block-based) system that stores data across, in one implementation, an array of storage devices 125. The block-level system presents a file system 115 (which may be running on a server system 110) with a range of LBAs into which the file system 115 stores data. The block-level storage system 120 may receive instructions from the file system 115 to read from, or write to, a particular LBA. In response, the block-level storage system 120 maps the particular LBA to a physical storage block. The storage system 120 may further employ a RAID level (RAID 0, RAID 5, RAID 6 or RAID 10, among others) using a storage controller 130 to manage the storage devices 125 as one or more RAID volumes. RAID techniques offer improved read and write performance from and to the storage space available to the storage devices 125, in addition to providing redundancy in the event that one or more storage devices 125 experiences a hardware failure.

The file system 115, rather than the block-level storage system 120, decides where among a range of LBAs to store parts of a stream of data, and sequential data may therefore be stored in non-sequential storage blocks. This reduces the efficiency of reads from the storage devices 125, since read-ahead processes cannot be used efficiently by the storage system 120. The systems and methods set forth in the description that follows may be used to read data from non-sequential storage blocks such that reads of data streams can be performed more efficiently.

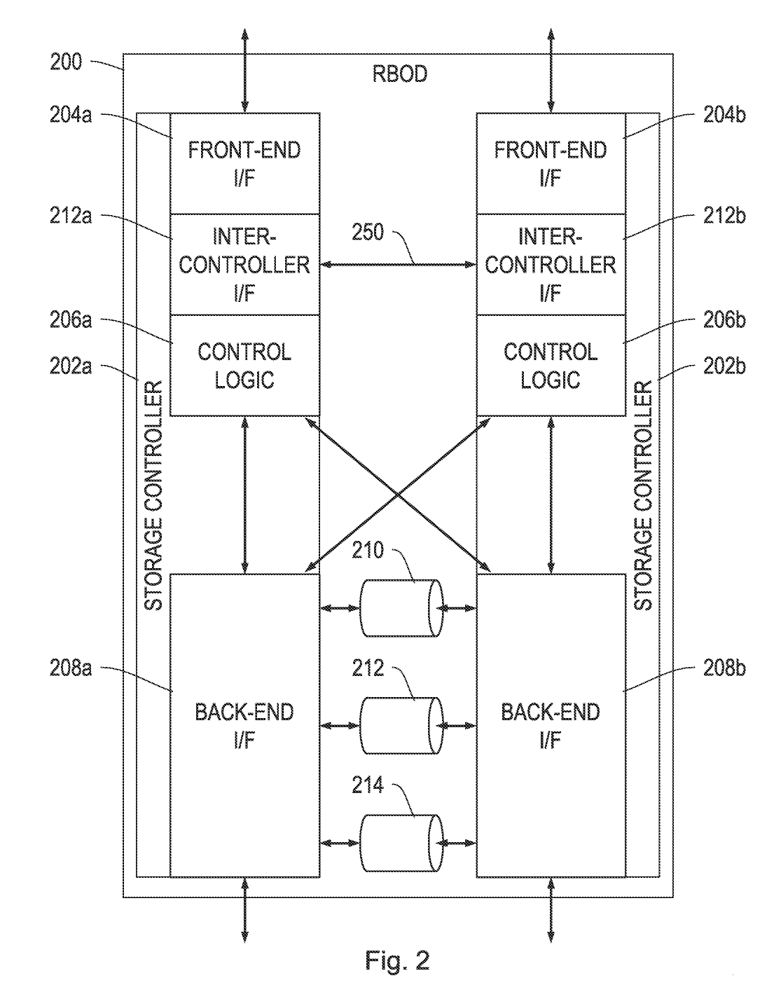

FIG. 2 is a schematic block diagram of an exemplary embodiment of a storage enclosure RBOD 200 (RAID Box of Disks). RBOD 200 may be used, in one implementation, in the storage environment 100 from FIG. 1 as an alternative embodiment of storage system 120 attached to one or more storage devices 125. RBOD 200 may employ the systems and methods for tracking a sequential data stream stored in non-sequential storage blocks, as described herein. RBOD 200 may be used as a building block for configuring large storage systems, and is a module that may be used in a standalone configuration as a simple, smaller RAID storage system or may be used as a module configured with other storage enclosure modules in a larger storage system configuration.

RBOD 200 comprises a plurality of redundant storage controllers 202a and 202b. Controllers 202a and 202b are similar storage controllers coupled with one another to provide redundancy in case of failure of one of its mates among the multiple storage controllers (or failure of any storage controller in a system comprising one or more RBODs 200 or other storage controllers). In the exemplary embodiment of FIG. 2, all of the multiple storage controllers (202a and 202b) are interconnected via path 250 through a respective inter-controller interface (212a and 212b). Inter-controller interfaces 212a and 212b and path 250 may provide any of a variety of well known communication protocols and media including, for example, PCI (e.g., PCI Express), SAS, Fibre Channel, Infiniband, Ethernet, etc. This inter-controller interface and medium is typically utilized only for exchanges between the controllers within the storage enclosure 200. Controller to controller communications relating to the redundancy and associated watchdog signaling may be applied to this inter-controller interface and the communication medium.

Each controller 202a and 202b comprises control logic 206a and 206b, respectively. Control logic 206a and 206b represent any suitable circuits for controlling overall operation of the storage controller 202a and 202b, respectively. In some exemplary embodiments, control logic 206a and 206b may be implemented as a combination of special and/or general purpose processors along with associated programmed instructions for each such processor to control operation of the storage controller. For example, control logic 206a and 206b may each comprise a general purpose processor and associated program and data memory storing programmed instructions and data for performing distributed storage management on volumes dispersed over all storage devices of the storage system that comprises RBOD 200. Control logic 206a and 206b interact with one another through inter-controller interfaces 212a and 212b, respectively, to coordinate redundancy control and operation. In such a redundant configuration, each controller 202a and 202b monitors operation of the other controller to detect a failure and to assume control from the failed controller. Well known watchdog timer and control logic techniques may be employed in either an “active-active” or an “active-passive” redundancy configuration of the storage controllers 202a and 202b. In one embodiment, these techniques may associate a timer with a respective controller 202a or 202b, wherein the timer is implemented in hardware or software. In response to the timer not being reset by the respective controller 202a or 202b, wherein failing to rest the timer may be indicative of an unresponsive controller state, a reset process may be triggered. The reset process may then restore the respective controller 202a or 202b to a default and operational state.

Further, each of the multiple storage controllers 202a and 202b comprises a corresponding front-end interface 204a and 204b, respectively, coupled with the control logic 206a and 206b, respectively. Front-end interfaces couple their respective storage controller (202a and 202b) with one or more host systems. When RBOD 200 is used in the storage environment 100 from FIG. 1 as an alternative embodiment of storage system 120 attached to one or more storage devices 125, the host systems to which the front-end interfaces couple are server systems 110. In some exemplary, high reliability applications, front-end interfaces 204a and 204b may each provide multiple, redundant communications paths with any attached host system.

Storage controllers 202a and 202b comprise corresponding back-end interfaces 208a and 208b, respectively. The back-end interfaces 208a and 208b further comprise an appropriate circuit for coupling either of storage controllers 202a and 202b to a switched fabric communication medium. In general, back-end interfaces 208a and 208b may be switching devices that form a part of the switched fabric communication medium. However, physically, back-end interfaces 208a and 208b are integrated within the storage enclosure RBOD 200. In such exemplary embodiments, control logic 206a and 206b may comprise interface circuits adapted to couple the control logic with the fabric as represented by the back-end interfaces 208a and 208b. These and other design choices regarding the level of integration among control logic 206, inter-controller interfaces 212, front-end interfaces 204 and back-end interfaces 208 will be readily apparent to those of ordinary skill in the art.

In some exemplary embodiments, the switched fabric communication medium may be a SAS switched fabric. In such an embodiment, each back-end interface 208a through 208b may be a SAS expander circuit substantially integrated with its respective storage controller 202a and 202b within storage enclosure RBOD 200. As noted above, in such an embodiment, control logic 206a and 206b may further comprise an appropriate SAS interface circuit (i.e., a SAS initiator circuit) for coupling with the back-end SAS expander 206a and 206b, respectively. Back-end interfaces 208a and 208b may also be linked to allow data transfer between controllers 202a and 202b.

In another exemplary embodiment, the switched fabric communication medium may be a Fibre Channel switched fabric and each back-end interface 208a and 208b may be a Fibre Channel switch substantially integrated with its respective storage controller 202a and 202b within the storage enclosure RBOD 200. Such Fibre Channel switches couple corresponding storage controllers 202a and 202b to other components of the Fibre Channel switched fabric communication medium. Also as noted above, in such an embodiment, control logic 206a and 206b may further comprise appropriate FC interface circuits to couple with respective back-end FC switches 208a and 208b.

In some embodiments, storage enclosure RBOD 200 comprises locally attached storage devices 210, 212, and 214. Such storage devices may be multi-ported (e.g., dual-ported) such that each storage device couples to all back-end interface circuits 208a and 208b integrated with corresponding storage controllers 202a and 202b within the enclosure RBOD 200. These storage devices 210, 212, and 214 are directly attached through back-end interfaces 208a and 208b to the switched fabric communication medium (e.g., attached through SAS expanders or Fibre Channel switches 208a and 208b with the remainder of the switched fabric communication medium).

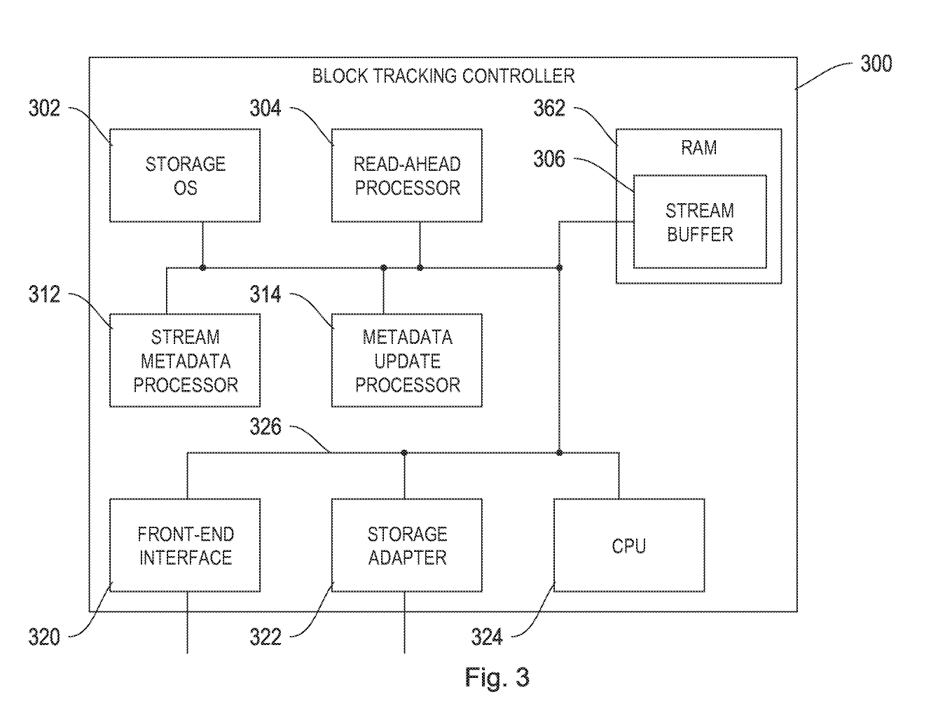

FIG. 3 is a schematic block diagram of a block tracking controller 300, as described herein for use in the storage system 120 of FIG. 1 and RBOD 200 of FIG. 2. Those skilled in the art will understand that the embodiments described herein may apply to any type of special-purpose computer (e.g., storage system) or general-purpose computer, including a standalone computer, embodied or not embodied as a block tracking controller 300. To that end, block tracking controller 300 can be broadly, and alternatively, referred to as a computer system. Moreover, the teachings of the embodiments described herein can be adapted to a variety of storage system architectures including, but not limited to, a network-attached storage environment, and a storage area network and disk assembly directly attached to a server computer. The term “storage system” should, therefore, be taken broadly to include such arrangements.

The block tracking controller 300 tracks and reads a stream of data stored in non-sequential storage blocks on a storage device. The block tracking controller 300 may, in some implementations, include a storage OS 302, a read-ahead processor 304, a stream metadata processor 312 and a metadata update processor 314. The block tracking controller 300 may also have a stream buffer 306 implemented within RAM 362, in addition to a front-end interface 320, a storage adapter 322, a central processing unit (CPU) 324, and a system bus 326.

The front-end interface 320 comprises the mechanical, electrical and signaling circuitry to connect the block tracking controller 300 to a server system, such as server system 110 from FIG. 1, over a computer network, such as computer network 150. The block tracking controller 300 may further include one or more front-end interfaces 320. A front-end interface 320 has a unique address (the address may be, among others, an IP, Fiber Channel, serial attached SCSI (SAS), or InfiniBand address) and may reference data access ports for server systems 110 to access the block tracking controller 300, wherein the front-end interface 320 accepts read/write access requests from the server systems 110 in the form of data packets.

The storage adapter 322 cooperates with the storage operating system (Storage OS) 302 executing on the block tracking controller 300 to access data requested by a server system 110. The data may be stored on storage devices, such as storage devices 125 from FIG. 1, which are attached, via the storage adapter 322, to the block tracking controller 300 or other node of a storage system as defined herein. The storage adapter 322 includes input/output (I/O) interface circuitry that couples to the storage devices 125 over an I/O interconnect arrangement, such as a conventional high-performance, Fibre Channel serial link topology, or SAS (serial attached SCSI). In response to an access request received from a server system 110, data may be retrieved by the storage adapter 322 and, if necessary, processed by the CPU 324 (or the adapter 322 itself) prior to being forwarded over the system bus 326 to the front-end interface 320. Upon reaching the front-end interface 320, the data may be formatted into a packet and returned to the server system 110.

In some embodiments, the storage devices 125 comprise storage devices that are configured into a plurality of e.g., RAID (redundant array of independent disks) groups using RAID levels RAID 0, RAID 5, RAID 6, RAID 10, and variants, such as RAID-DP, among others, whereby multiple storage devices 125 are combined into a single logical unit (i.e., RAID volume). In a typical RAID volume, storage devices 125 of the group share or replicate data among the disks which may increase data reliability or performance. When using RAID methods, the CPU 324 may map a RAID volume's (also referred to as a logical unit) logical blocks addresses (LBAs) to physical storage device 125 LBAs.

Storage OS 302, read-ahead processor 304, and stream tracker 310 may be implemented in persistent storage or volatile memory, without detracting from the spirit of the implementation of the storage system 300. Furthermore, the software modules, software layers, or threads described herein may comprise firmware, software, hardware, or any combination thereof that is configured to perform the processes described herein. For example, the storage OS 302 may comprise a storage operating system engine having firmware or software and hardware configured to perform embodiments described herein. Portions of the storage OS 302 are typically resident in memory, however various computer readable media may be used for storing and executing program instructions pertaining to the storage OS 302.

The read-ahead processor 304 may generally be used to buffer a part of a sequential data stream, for which a read request is anticipated in the future. The read-ahead processor 304 may initiate a read of a part of a sequential data stream based on instructions from one or more read-ahead processes, wherein the read-ahead processes may be stored, in some implementations, in the read-ahead processor 304. In order to implement a read-ahead process, the read-ahead processor 304 may read a part of a data stream from one or more storage devices 125 using storage adapter 322, and write it to a stream buffer 306. Stream buffer 306 may be implemented partially or wholly in RAM 362, which has lower access time (time required to deliver a data request) than that of the storage device 125. In another implementation, RAM 362 could be replaced by a Storage Class Memory (SCM).

Stream metadata processor 312 may create metadata to keep track of the parts of a sequential data stream, wherein the parts of the sequential data stream may be stored in non-sequential storage blocks. In one implementation, the metadata may be created as a stream of data is written to, or read from, one or more storage devices, such as storage devices 125 from FIG. 1, which may be HDDs. The metadata created may also be stored on one or more storage devices 125, and subsequently read by the read-ahead processor 304.

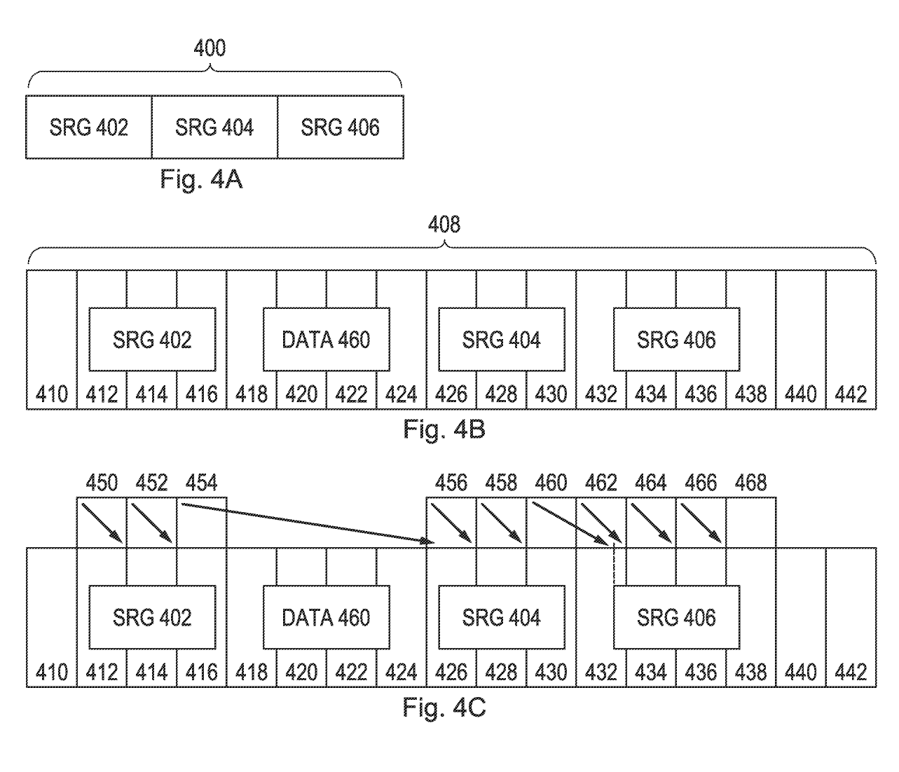

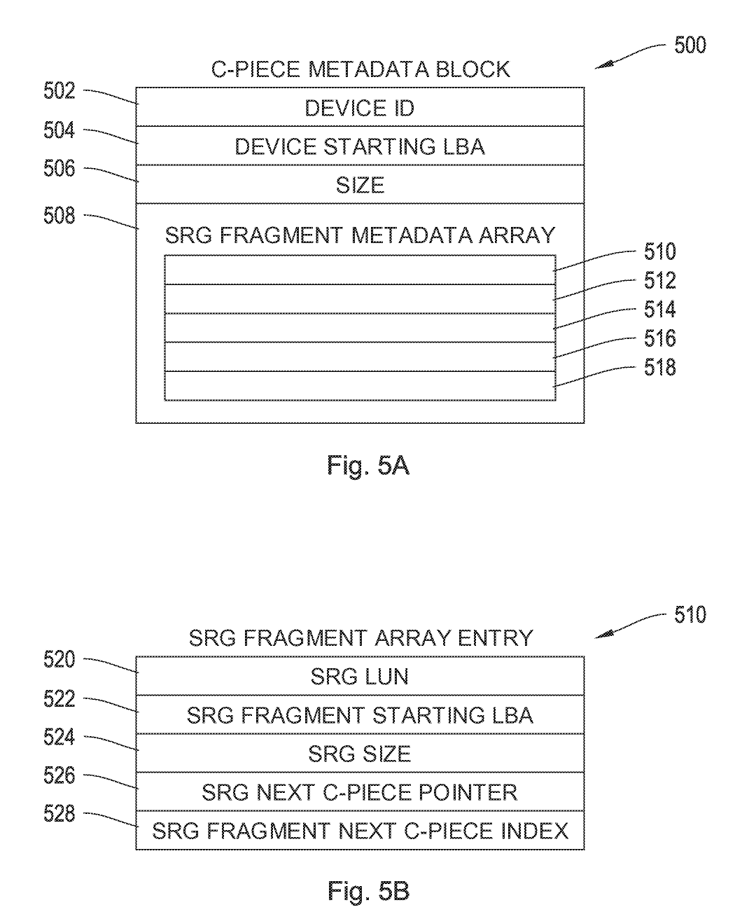

A file system 115 may be presented, by the storage system 120, with a range of LBAs into which data (a sequential data stream, for example) can be stored in a RAID volume, wherein storage devices 125 may be grouped as a RAID volume. The file system 115 may, however, store a sequential data stream at non-sequential LBAs, which map to non-sequential storage blocks on the storage devices 125. Storing a sequential data stream in non-sequential storage blocks would previously have prevented the use of a read-ahead processes by a block-level storage system 120, but by creating metadata, the stream metadata processor 312 enables read-ahead processes to predict, using normal known prediction methods, which parts of a sequential data stream stored in non-sequential storage blocks will be requested in the future. A more detailed description of this metadata is given in relation to FIGS. 4A-4C, and FIGS. 5A and 5B.

The read-ahead processor 304 may read a part of a sequential data stream from a storage device (such as a storage device 125 from FIG. 1, which may be a HDD), and write it to the stream buffer 306. The metadata update processor 314 allows the metadata created by the stream metadata processor 312 to be corrected if it is discovered that the metadata does not correctly point between sequential parts of a given data stream, as described in relation to the exception operation below. This discovery may be the result of a failed attempt by the CPU 324 to implement a retrieval function to retrieve a part of the sequential data stream from the stream buffer 306. Incorrect metadata may arise due to the lack of communication between a file system 115 and the block-level storage system 120 during the initial writing of sequential data to a storage device 125. The stream metadata processor 312 includes processes that recognize when a stream of data is being written to a storage device 125, wherein all data included in a write request from a single file system 115 may be recognized as a single data stream. This recognition process, in some instances, may not be accurate, resulting in incorrect metadata being written by stream metadata processor 302.

A real-time request for a part of a sequential data stream may be made to the block tracking controller 300 from an external source, such as a server system 110 from FIG. 1. In response, the CPU 324 will attempt to retrieve the requested part of the sequential data stream from the stream buffer 306. If the requested part of the sequential data stream is not buffered to the stream buffer 306, the CPU 324 implements a retrieval function directly on a storage device, and retrieves the part of the sequential data stream from the storage device through the storage adapter 322. A failed attempt by the CPU 324 to implement a retrieval function to retrieve a part of the sequential data stream from the stream buffer 306 results in an execution of an exception operation. This exception operation calls metadata update processor 314 to implement a function to re-write the metadata associated with the previous part of the data stream. This updated metadata reflects the storage location given by the file system 115 in an instruction to CPU 324 to retrieve the part of the data stream.

FIGS. 4A-4C schematically depict a process for tracking a sequential data stream stored in non-sequential storage blocks. In particular, FIG. 4A depicts a sequential data stream 400, which may, in one embodiment, be video data. A file system, such as file system 115 from FIG. 1, may divide the sequential data stream 400 into smaller parts, wherein these smaller parts are depicted in FIG. 4A as sequential request group (SRG) 402, SRG 404, and SRG 406. Note that the sequential data stream 400 may generally be broken up into any number of parts, or sequential request groups, and while SRG 402, SRG 404, and SRG 406 are depicted as the same size, this is not always the case.

A sequential request group, such as SRG 402, SRG 404, and SRG 406, is a group of data that is accessed in a specific order, or in-sequence, such as data associated with a video. An SRG may be of any size, and FIG. 4A depicts one implementation wherein SRG 402, SRG 404, and SRG 406 are each approximately 2.5 GB in size. Reading an SRG, such as SRG 402, SRG 404, and SRG 406, can be performed using a read-ahead process.

FIG. 4B schematically depicts a RAID volume 408, wherein RAID volume 408, may be set up by storage controller 130 in storage system 120 using the storage space made available by the plurality of storage devices 125. RAID volume 408 appears as a single storage device to a file system 115. The storage system 120 may implement a particular RAID level to form RAID volume 408 (such as RAID 0, RAID 5, RAID 6, or RAID 10, among others), and distribute data across the plurality of storage devices 125 that make up the RAID volume 408.

Each storage device 125 has physical storage device (e.g., disk) blocks into which data is stored. An abstraction of a physical disk block is referred to as a storage block, such as storage blocks 410-442. A storage block 410-442 may correspond to a single disk block, or many physical disk blocks. A storage block 410-442 may therefore have a storage capacity equal to a physical disk block, or equal to many times that of a physical disk block, and measuring several gigabytes in size or more. The storage controller 130 stores the mapping between a storage block 410-442 and a single physical disk block or a range of physically-adjacent disk blocks. An LBA is a further level of abstraction, such that the storage controller 130 also stores a mapping between a LBA and a storage block 410-442. As mentioned previously, a storage block 410-442 may have a storage capacity of multiple times that of a physical disk block, hence there may be multiple LBAs mapped to multiple parts of a single storage block 410-442.

The storage controller 130 may present a file system 115 with a range of LBAs into which the file system 115 can store data. These LBAs are sequentially numbered, but two sequentially-numbered LBAs may or may not map to physically-adjacent physical disk blocks on the same storage device 125. Two sequentially-numbered LBAs do map to sequential parts of a single storage block, or to two parts of two sequentially-numbered storage blocks 410-442. Therefore, data stored in non-sequential LBAs corresponds to storage in non-sequential storage parts of a single storage block (410-442), or to non-sequential storage blocks

Storage blocks 410-442 may alternatively be referred to as C-Pieces 410-442, wherein C-Pieces 410-442 of FIG. 4B have storage capacities of 1 GB. C-Pieces 410-442 are depicted in FIG. 4B as having the same size, but in other implementations, may differ in size. A pair of C-Pieces depicted adjacent to one another in FIG. 4B (such as C-Pieces 410 and 412) are stored on different storage devices 125.

The storage controller 130 may be used to present a file system 115 on a server system 110 with a range of LBAs into which the file system 115 can store the sequential data stream 400. In some instances, such as that depicted in FIG. 4B, the file system 115 may choose to store the SRGs (SRG 402, 404, and 406) that make up the sequential data stream 400 at non-sequential LBAs. These non-sequential LBAs correspond to non-sequential C-Pieces (410-442), hence SRG 402, 404 and 406 are depicted spaced apart from one another within C-Pieces 410-442. Note that the gap between a pair of SRGs, such as between SRG 402 and SRG 404, may be used by, among others, the file system 115 to store other data that does not form part of the sequential data stream 400, such as data 460.

Read-ahead processes may be used by the block-level storage controller 130 to predict, and buffer ahead of time, parts of an SRG (such as SRG 402, 404, or 406) that will be required in the future. While the file system 115 keeps track of where within the range of LBAs the SRGs 402, 404, 406 are stored, the block-level storage controller 130 is not explicitly aware of how the file system 115 is using the storage space associated with the presented range of LBAs to store a sequential data stream 400. The systems and methods described herein, however, allow read-ahead processes to be successfully employed to buffer between discontinuous SRGs, such as SRGs 402, 404, and 406 in FIG. 4B, wherein metadata may be associated with C-Pieces 410-442 to facilitate read ahead processes, as depicted in FIG. 4C.

FIG. 4C depicts C-Piece metadata blocks 450-468 associated with C-Pieces 412-416, and 426-438. These C-Pieces 412-416, and 426-438 are used to store part of one or more SRGs (402-406) that make up the sequential data stream 400. The metadata stored in a C-Piece metadata block, such as C-Piece metadata block 450, is created by the stream metadata processor 312 as a sequential data stream 400 is being written to a RAID volume 408.

C-Piece metadata blocks 450-454 and 456-468 represent metadata structures used to track data stream 400. There may, however, be an empty metadata structure associated with each C-Piece 410-442, and created by the storage controller 130 during the division of the RAID volume 408 into C-Pieces 410-442. Note that while, for example, C-Piece metadata block 450 is associated with C-Piece 412, it may be stored at a separate location to the data stored in C-Piece 412.

The detailed data structure of a C-Piece metadata block is described with reference to FIG. 5A and FIG. 5B, but from FIG. 4C it is apparent that a C-Piece metadata block (450-468) contains a pointer to the next C-Piece (410-442) that contains part of the sequential data stream 400. This pointer allows read-ahead processes to be used where previously they would fail upon encountering discontinuities between parts (SRGs 402, 404, and 406) of the sequential data stream 400.

FIG. 5A is a schematic block diagram of an exemplary data structure of a C-Piece metadata block 500. Metadata block 500 may be one of an array of metadata block data structures. A stream metadata processor 312 may generate and store metadata in the C-Piece metadata block 500 to track a data stream, such as data stream 400, stored in non-sequential C-Pieces, such as C-Pieces 412-416 and 426-438.

C-Piece metadata block 500 has data fields that are populated as a sequential data stream 400 is written to, or read from, a RAID volume 408. These data fields include a device ID 502, which identifies the physical HDD or other storage device that provides the storage space for the C-Piece associated with metadata block 500. This device ID 502 may be assigned by a storage controller, such as storage controller 130.

The data field labeled as the device starting LBA 504 is the first logical block address of the storage space available to the C-Piece associated with the C-Piece metadata block 500, and the data field labeled as size 506 corresponds to the physical storage space (in number of disk blocks) assigned to the C-Piece associated with the C-Piece metadata block 500.

SRG fragment metadata array 508 contains data for tracking SRGs written within C-Pieces. The array 508 has an entry for, in this implementation, five streams of data that may be written to the C-Piece associated with C-Piece metadata block 500, wherein each of the five streams is associated with an array entry 510, 512, 514, 516, or 518. Note that each of the array entries 510-518 will be associated with an SRG, and the number of entries in array 508 may be more or less than five, corresponding to the number of streams to be tracked.

FIG. 5B schematically depicts an SRG fragment array entry 510, which corresponds to an entry in the SRG fragment metadata array 508 from FIG. 5A. The array entry 510 stores information associated with an SRG, such as SRG 402 associated with C-Piece 412 from FIG. 4C. An SRG, such as SRG 402 from FIG. 4C, may span more than one C-Piece (in FIG. 4C, SRG 402 spans C-Pieces 412-416). That portion of SRG 402 stored in each of C-Pieces 412-416 may be referred to as a fragment, and the information stored in array entry 510 is associated with the fragment of the SRG 402 that is stored in C-Piece 412.

The data stored in SRG fragment array entry 510 includes an SRG LUN 520, which is the logical unit number, or RAID volume, that the SRG associated with array entry 510 is stored into. The SRG fragment starting LBA 522 is the logical block address within the LUN/RAID volume (RAID volume given by SRG LUN 520) that the SRG starts at. This starting LBA 522 is equivalent to an offset value into the C-Piece that the C-Piece metadata block 500 is associated with, and corresponds to the starting point of the stored part of the data stream within this C-Piece. Alternatively, the data field storing SRG fragment starting LBA 522 could store an offset value corresponding to a number of bytes, which would convey the same information.

SRG size 524 is the number of contiguous blocks from the SRG fragment starting LBA 522 that are occupied by the SRG fragment. SRG next C-Piece pointer 526 is a pointer to the next C-Piece metadata structure storing part of the data stream to which the SRG associated with the array entry 510 belongs. The pointer 526 is, in some implementations, an LBA of the storage location of the first physical disk block associated with the next C-Piece metadata structure storing part of the data stream. SRG next C-Piece pointer 526 has a null value if the C-Piece associated with C-Piece metadata block 500 stores the end of the data stream.

SRG fragment next C-Piece index 528 is the index number of the SRG fragment metadata array 508 of the next C-Piece (given by pointer 526), which should be used to find information on the next SRG fragment in the data stream.

Using the information stored in the SRG fragment array entry 510, a read-ahead processor 304 is able to find pointers (SRG next C-Piece pointer 526) to sequential parts of a data stream, thereby allowing read-ahead processes to be used efficiently.

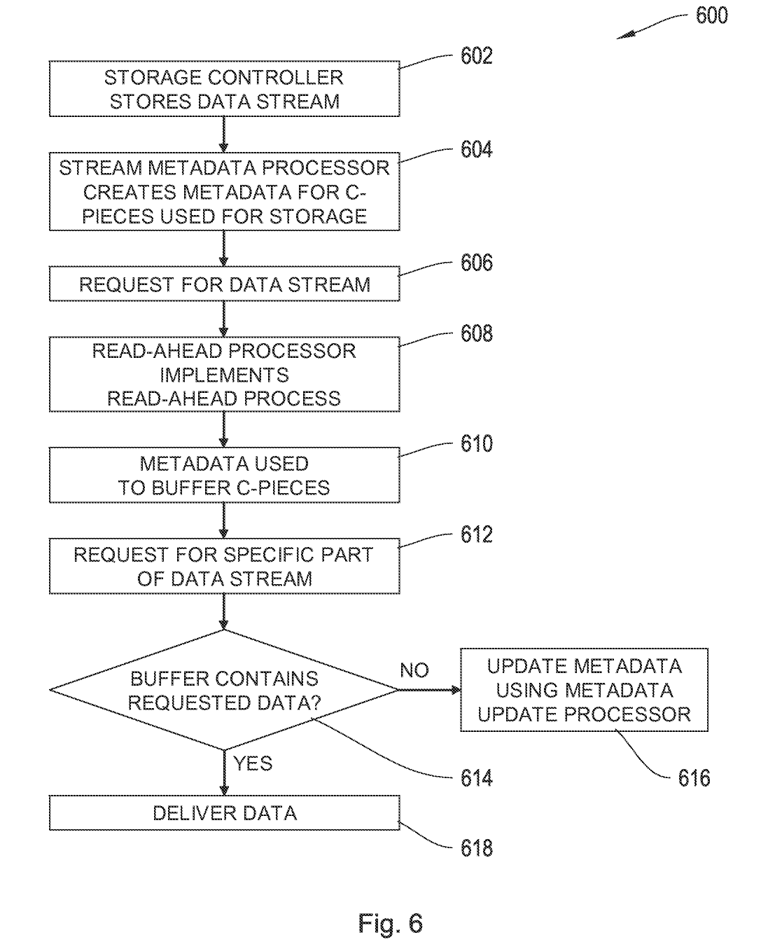

FIG. 6 is a flowchart diagram of a process 600 for tracking a data stream using metadata that allows read-ahead processes to be used when parts of the data stream are stored in non-sequential disk blocks. The process starts at step 602 as a data stream, such as data stream 400, is being stored into, in one implementation, a RAID volume using a storage controller, such as storage controller 130. The process proceeds to step 604 as the stream metadata processor 312 stores metadata into one or more C-Piece metadata blocks 500 associated with one or more C-Pieces, wherein the one or more C-Pieces are used to store part of the data stream 400. For example, C-Pieces 412-416 are used to store SRG 402, which is part of data stream 400 from FIG. 4C. As data is written to C-Pieces 412, 414, and 416, the stream metadata processor 312 writes metadata into the C-Piece metadata blocks 450, 452, and 454 shown in FIG. 4C.

Step 606 is a request for the data stream 400 from, in one embodiment, a server system 110. The request may be for the data stream 400 stored at a specific LBA, wherein this specific LBA is mapped to a C-Piece by storage controller 130, and in particular, may be mapped to C-Piece 412 for data stream 400.

Step 608 is a response to the request for the data stream 400, wherein the response includes the implementation of a read-ahead process using a read-ahead processor 312. The read-ahead process may, in one implementation, search an array of C-Piece metadata blocks 500 to find the specific metadata block associated with the C-Piece 412, which stores a first part of the data stream 400. In this example, the specific metadata block is C-Piece metadata block 450 from FIG. 4C. Having found the C-Piece metadata block 450 associated with the start of the data stream 400, the read-ahead process uses the pointers stored in the C-Piece metadata to anticipate which C-Pieces will be required in future to deliver data stream 400 to the requesting server system 110, such as C-Pieces 414-416, and 426-438 from FIG. 4C.

Step 610 buffers anticipated C-Pieces into stream buffer 306 using the pointers stored in the metadata associated with C-Pieces 412-416, and 426-438, which store the data stream 400. The read-ahead process buffers the contents of these anticipated C-Pieces 414-416 and 426-438 to improve the latency of the data from storage device (HDD) to the data requester (server system 110).

Step 612 of process 600 describes a real-time request, from server system 110, for a specific part of the data stream 400. The request is an instruction to deliver the contents stored at a specific LBA. In response, at step 614 the block tracking controller 300 may first check for the requested data in the stream buffer 306, and if the requested data is not available in the stream buffer 306, read the requested data directly from a storage device in the RAID volume 408. If the requested data is available in the stream buffer 306, the process proceeds to step 618 and the data is delivered to the requesting server 110. If, however, the requested data is not available in the stream buffer 306, the process proceeds to step 616, and the metadata update processor 314 updates the metadata associated with the last C-Piece from which a successful read-ahead was completed. For example, if the data associated with C-Piece 416 is not available in the stream buffer 306, the metadata update processor 314 is used to update the C-Piece metadata block 452 associated with C-Piece 414.

Some embodiments of the above described may be conveniently implemented using a conventional general purpose or a specialized digital computer or microprocessor programmed according to the teachings herein, as will be apparent to those skilled in the computer art. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols, and chips that may be referenced throughout the above description may be represented by voltages, currents, electromagnetic waves, magnetic fields or particles, optical fields or particles, or any combination thereof.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some embodiments different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

Accordingly, it will be understood that the invention is not to be limited to the embodiments disclosed herein, but is to be understood from the following claims, which are to be interpreted as broadly as allowed under the law.

Those of skill would further appreciate that the various illustrative logical blocks, modules, circuits, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The techniques or steps of a method described in connection with the embodiments disclosed herein may be embodied directly in hardware, in software executed by a processor, or in a combination of the two. In some embodiments, any software module, software layer, or thread described herein may comprise an engine comprising firmware or software and hardware configured to perform embodiments described herein. In general, functions of a software module or software layer described herein may be embodied directly in hardware, or embodied as software executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

What is claimed is:

1. A method for reading a data stream stored in non-sequential storage blocks, comprising:
storing a first part of a data stream in a first storage block and a second part of a data stream in a second storage block being sequentially offset from the first storage block;
generating, using a stream metadata processor, a first metadata block associated with the first storage block;
storing, in the first metadata block using the stream metadata processor, a pointer to the second storage block; and
buffering the second part of the data stream into a stream buffer as the first part of the data stream is being read to a requesting computer system, wherein a read-ahead processor reads the first metadata block, and uses the pointer to the second storage block to buffer the second part of the data stream prior to a request for the second storage block being made from the requesting computer system.

2. The method according to claim 1, further comprising;
generating, using the stream metadata processor, the first and a second metadata block as the data stream is being written to the first and second storage blocks, respectively.

3. The method according to claim 1, wherein the first and second storage blocks are physical blocks on one or more storage devices.

4. The method according to claim 1, wherein the first and second storage blocks are abstractions of physical disk blocks, and subdivisions of a virtual storage volume.

5. The method according to claim 2, wherein the first and second metadata blocks are stored separately from the first and second storage blocks.

6. The method according to claim 5, wherein the first and second metadata blocks are stored in a metadata block array for the data stream.

7. The method according to claim 1, wherein generating the pointer includes determining the logical block address where the second metadata block is stored.

8. The method according to claim 1, wherein generating the pointer includes assigning a null value if the end of the data stream is stored in the first storage block.

9. The method according to claim 1, further comprising;
storing, using the stream metadata processor, an offset value in the first metadata block representing the point in the second storage block at which the second part of the data stream starts.

10. The method according to claim 9, wherein the offset value is a number of bytes.

11. The method according to claim 1, further comprising;
storing, using the stream metadata processor, a first and a second logical unit number in the first and a second metadata block, respectively, wherein the first and the second logical unit numbers correspond to physical storage devices used to store the first and second parts of the data stream, respectively.

12. The method according to claim 1, further comprising;
storing, using the stream metadata processor, a first size value and a second size value in the first and a second metadata block, respectively, wherein the first size value and the second size value correspond to the end points of the first and second parts of the data stream, respectively.

13. The method according to claim 1, further comprising;
updating, using a metadata update processor, the first metadata block if the requesting computer system reads a third part of the data stream directly from a third storage block instead of the second part of the data stream from the stream buffer.

14. The method according to claim 1, wherein the requesting computer system uses file metadata to request the first and second parts of the data stream in sequence, and the file metadata is not available to the read-ahead processor.

15. A system for improving read performance of a data stream stored in two non-sequential storage blocks, comprising:
a stream metadata processor, configured to:
store a first part of a data stream in a first storage block and a second part of a data stream in a second storage block being sequentially offset from the first storage block,
generate a first metadata block associated with a first storage block,
store, in the first metadata block, a pointer to the second storage block; and
a read-ahead processor, for buffering the second part of the data stream into a stream buffer, wherein the read-ahead processor reads the first metadata block, and uses the pointer to the second storage block to buffer the second part of the data stream prior to a request for the second storage block being made from a requesting computer system.

16. The system according to claim 15, further comprising;
a stream metadata processor, for generating the first and a second metadata block as the data stream is being written to the first and second storage blocks, respectively.

17. The system according to claim 15, wherein the first and second storage blocks are physical blocks on one or more storage devices.

18. The system according to claim 15, wherein the first and second storage blocks are abstractions of physical disk blocks, and subdivisions of a virtual storage volume.

19. The system according to claim 16, wherein the first and second metadata blocks are stored separately from the first and second storage blocks.

20. The system according to claim 19, wherein the first and second metadata blocks are stored in a metadata block array for the data stream.

21. The system according to claim 15, wherein generating the pointer includes determining, by the stream metadata processor, the logical block address where the second metadata block is stored.

22. The system according to claim 15, wherein generating pointer includes assigning, by the stream metadata processor, a null value if the end of the data stream is stored in the first storage block.

23. The system according to claim 15, further comprising;
the stream metadata processor for storing an offset value in the first metadata block representing the point in the second storage block at which the second part of the data stream starts.

24. The system according to claim 23, wherein the offset value is a number of bytes.

25. The system according to claim 15, further comprising;
the stream metadata processor, for storing a first and a second logical unit number in the first and a second metadata block, respectively, wherein the first and the second logical unit numbers correspond to the physical storage devices used to store the first and second parts of the data stream, respectively.

26. The system according to claim 15, further comprising;
the stream metadata processor, for storing a first size value and a second size value in the first and a second metadata block, respectively, wherein the first size value and the second size value correspond to the end points of the first and second parts of the data stream, respectively.

27. The system according to claim 15, further comprising;
a metadata update processor, for updating the first metadata block if the requesting computer system reads a third part of the data stream directly from a third storage block instead of the second part of the data stream from the stream buffer.

28. The system according to claim 15, wherein the requesting computer system uses file metadata to request the first and second parts of the data stream in sequence, and the file metadata is not available to the read-ahead processor.

29. A method for storage management of a data stream, comprising;
dividing the data stream into a plurality of segments;
storing a first data stream segment, from the plurality of segments, in a block of a block-level storage system;
storing metadata in the block-level storage system and associated with the first data stream segment containing the storage location of a second data stream segment, from the plurality of segments, that follows sequentially from the first data stream segment; and
buffering the second data stream segment using a block-level storage system read-ahead process, wherein the read-ahead process uses the stored metadata associated with the first data stream segment to anticipated a request from a file system for the second data stream segment.
